(19) United States
(12) Patent Application Publication
(10) Pub. No.: US 2013/0008411 A1
(43) Pub. Date: Jan. 10, 2013

(54) COUPLING DEVICE

(76) Inventors: Giandomenico Serra, S. Giuliano Terme (PI) (IT); Gisella Di Domizio, San Giuliano Terme (IT); Edoardo Giorgetti, Rosignano Marittimo (LI) (IT); Daniel Marc, Livorno (IT)

(21) Appl. No.: 13/637,080

(22) PCT Filed: Mar. 16, 2011
(86) PCT No.: PCT/EP2011/053960

§ 371 Date: Sep. 25, 2012

(30) Foreign Application Priority Data
Mar. 25, 2010 (EP) 10003222.6

(51) Int. Cl. F02M 61/14

(52) U.S. Cl. 123/470

(57) ABSTRACT

A coupling device for coupling a fuel rail to a cylinder head of a combustion engine may include: a fuel injector cup coupled to the fuel rail and facing the cylinder head, a first fastening element facing the fuel injector cup and fixedly coupled to the cylinder head, at least one first spring element arranged between the first fastening element and the fuel injector cup and/or between the fuel injector cup and the cylinder head, a support element arranged between the fuel rail and the cylinder head and fixedly coupled to the fuel rail, a second fastening element engaged with the support element and fixedly coupled to the cylinder head, and at least one second spring element arranged between the second fastening element and the support element and/or between the support element and the cylinder head. The first spring element(s) may comprise metal, and the second spring element(s) may comprise plastic.

### CROSS-REFERENCE TO RELATED APPLICATIONS

This application is a U.S. National Stage Application of International Application No. PCT/EP2011/053960 filed Mar. 16, 2011, which designates the United States of America, and claims priority to EP Application No. 10003222.6 filed Mar. 25, 2010, the contents of which are hereby incorporated by reference in their entirety.

### TECHNICAL FIELD

This disclosure relates to a coupling device for mechanically coupling a fuel rail to a cylinder head of a combustion engine.

### BACKGROUND

Coupling devices for mechanically coupling a fuel rail to a cylinder head of a combustion engine are in widespread use, in particular for internal combustion engines. Fuel can be supplied to an internal combustion engine by the fuel rail through a fuel injector. The fuel rail can be coupled to the cylinder head in different manners.

In order to keep pressure fluctuations during the operation of the internal combustion engine at a very low level, internal combustion engines are supplied with a fuel accumulator to which the fuel injectors are connected and which has a relatively large volume. Such a fuel accumulator is often referred to as a common rail. Known fuel rails comprise a hollow body with recesses in form of fuel injector cups, wherein the fuel injectors are arranged.

### SUMMARY

In one embodiment, a coupling device for mechanically coupling a fuel rail to a cylinder head of a combustion engine, the coupling device comprises: a fuel injector cup being designed to be hydraulically and mechanically coupled to the fuel rail and being arranged and designed to face the cylinder head, a first fastening element facing the fuel injector cup and being designed to be fixedly coupled to the cylinder head, at least one first spring element being arranged between the first fastening element and the fuel injector cup and/or being arrangeable between the fuel injector cup and the cylinder head, a support element being arranged between the fuel rail and the cylinder head and being designed to be fixedly coupled to the fuel rail, a second fastening element being in engagement with the support element and being designed to be fixedly coupled to the cylinder head, and at least one second spring element being arranged between the second fastening element and the support element and/or being arrangeable between the support element and the cylinder head, wherein the at least one first spring element consists of a metal or comprises a metal, and the at least one second spring element consists of a plastic or comprises a plastic.

In a further embodiment, one first spring element is arranged between the first fastening element and the fuel injector cup and a further first spring element is arrangeable between the fuel injector cup and the cylinder head, and the first spring elements consist of a metal or comprise a metal. In a further embodiment, one second spring element is arranged between the second fastening element and the support element and a further second spring element is arrangeable between the support element and the cylinder head, and the second spring elements consist of a plastic or comprise a plastic. In a further embodiment, at least one of the fastening elements is a screw.

### BRIEF DESCRIPTION OF THE DRAWINGS

Example embodiments will be explained in more detail below with reference to figures, in which:

FIG. 1 shows an example internal combustion engine in a schematic view,

FIG. 2 shows an example fuel feed device with a coupling device in a perspective view, and

FIG. 3 shows the example coupling device in a longitudinal sectional view along line III-III′ of FIG. 2.

### DETAILED DESCRIPTION

Some embodiments provide a coupling device for mechanically coupling a fuel rail to a cylinder head of a combustion engine which is simply to be manufactured and which facilitates a reliable and precise coupling between the fuel rail and the cylinder head.

For example, some embodiments provide a coupling device for mechanically coupling a fuel rail to a cylinder head of a combustion engine. The coupling device comprises a fuel injector cup being designed to be hydraulically and mechanically coupled to the fuel rail and being arranged and designed to face the cylinder head, a first fastening element facing the fuel injector cup and being designed to be fixedly coupled to the cylinder head, at least one first spring element being arranged between the first fastening element and the fuel injector cup and/or being arrangeable between the fuel injector cup and the cylinder head, a support element being arranged between the fuel rail and the cylinder head and being designed to be fixedly coupled to the fuel rail, a second fastening element being in engagement with the support element and being designed to be fixedly coupled to the cylinder head, and at least one second spring element being arranged between the second fastening element and the support element and/or being arrangeable between the support element and the cylinder head. The at least one first spring element consists of a metal or comprises a metal, and the at least one second spring element consists of a plastic or comprises a plastic.

The at least one first spring element consisting of a metal or comprising a metal can keep the displacement of the fuel injector cup small. Furthermore, the at least one second spring element consisting of a plastic or comprising a plastic can compensate the tolerances of the components of the fuel rail and the cylinder head to achieve a minimum mechanical stress for these components.

In one embodiment one first spring element is arranged between the first fastening element and the fuel injector cup and a further first spring element is arrangeable between the fuel injector cup and the cylinder head. The first spring elements consist of a metal or comprise a metal. This may have the advantage that the coupling of the fuel injector cup with the cylinder head allows an assembly of the cylinder head and the fuel rail without a direct contact between the cylinder head and the fuel injector cup. Consequently, a noise transmission between the cylinder head and the fuel rail can be kept small.

In a further embodiment one second spring element is arranged between the second fastening element and the support element and a further second spring element is arrangeable between the support element and the cylinder head. The second spring elements consist of a plastic or comprise a plastic. This may have the advantage that the coupling of the support element with the cylinder head allows an assembly of the cylinder head and the fuel rail without a direct contact between the cylinder head and the support element. Consequently, a noise trans-mission between the cylinder head and the fuel rail can be kept small.

In a further embodiment at least one of the fastening elements is a screw.

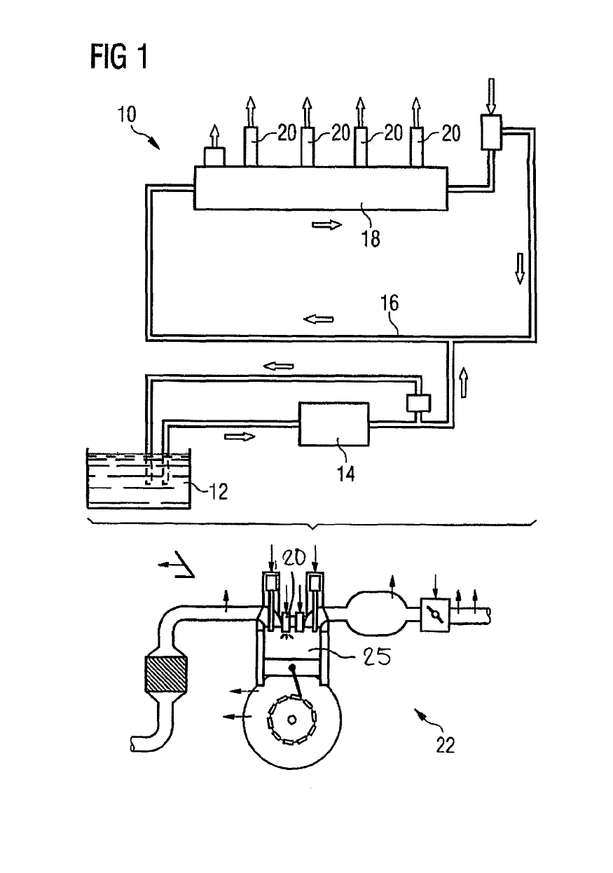

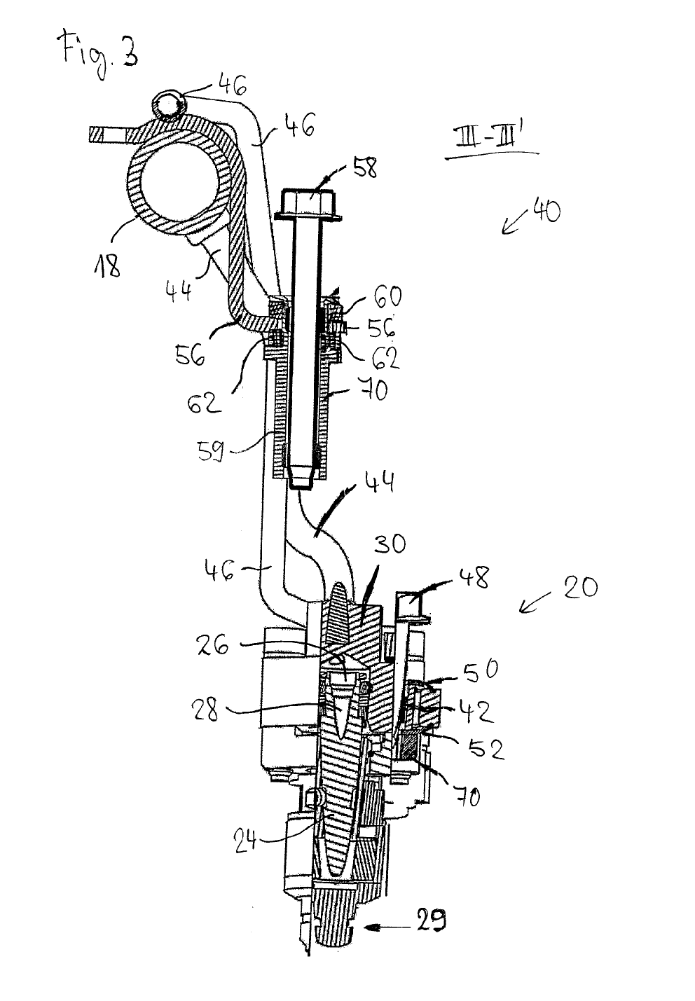

As shown in FIG. 1, a fuel feed device 10 is assigned to an internal combustion engine 22 which can be a diesel engine or a gasoline engine. It includes a fuel tank 12 that is hydraulically connected with a fuel pump 14. The output of the fuel pump 14 is connected to a fuel inlet 16 of a fuel rail 18. In the fuel rail 18, the fuel is stored for example under a pressure of about 200 bar in the case of a gasoline engine or of about 2,000 bar in the case of a diesel engine. Fuel injectors 20 are connected to the fuel rail 18 and the fuel is fed to the fuel injectors 20 via the fuel rail 18. The fuel injectors 20 are arranged in a cylinder head 70 of the internal combustion engine 22 (FIG. 3). In some embodiments, the fuel injectors 20 are not in direct contact with the cylinder head 70.

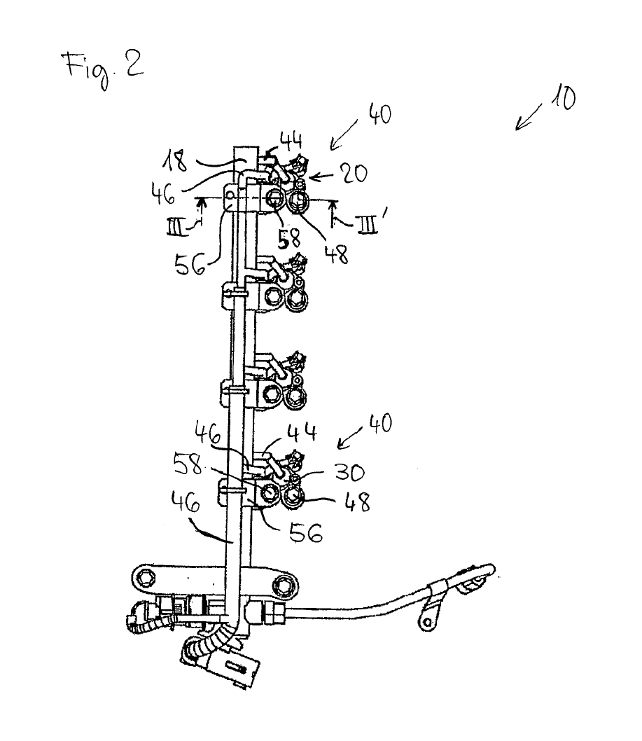

FIG. 2 shows a perspective view of the fuel feed device 10. FIG. 3 shows the fuel feed device 10 with the fuel injector 20. The fuel injector 20 has a fuel injector body 24. The fuel injector 20 is suitable for injecting fuel into a combustion chamber 25 of the internal combustion engine 22 (FIG. 1). The fuel injector 20 comprises a fuel inlet portion 26. Furthermore, a cavity 28 is arranged in the fuel injector body 24. In an injection mode fuel can flow from the fuel inlet portion 26 to the cavity 28 and further to an injection nozzle 29. Subsequently, the fuel may be injected into the combustion chamber 25. In a non-injecting mode a fuel flow through the cavity 28 and an injection of fuel into the combustion chamber 25 is prevented.

The fuel feed device 10 comprises a fuel injector cup 30 which is part of a coupling device 40. The fuel injector cup 30 is in engagement with the fuel inlet portion 26 of the fuel injector 20. The fuel injector cup 30 has a through hole 42.

The fuel injector cup 30 is mechanically and hydraulically coupled to the fuel rail 18 by a first pipe 44. The first pipe 44 enables a fluid flow from the fuel rail 18 to the fuel injector 20. The fuel feed device 10 comprises a second pipe 46. The second pipe 46 enables a fluid flow from the fuel injector 20 back to the fuel tank 12.

The coupling device 40 further comprises a first fastening element 48. In the shown embodiment, the first fastening element 48 is a screw. The first fastening element 48 is extending through the through hole 42. The first fastening element 48 is in engagement with the cylinder head 70. If the fastening element 48 is a screw, the fastening element 48 can be fixedly coupled to the cylinder head 70.

The coupling device 40 further comprises first spring elements 50, 52. One first spring element 50 is arranged axially between the fastening element 48 and the fuel injector cup 30. Another first spring element 52 is arranged axially between the fuel injector cup 30 and the cylinder head 70. The first spring elements 50, 52 consist of a metal or comprise a metal.

The coupling device 40 further comprises a support element 56 which is arranged between the fuel rail 18 and the cylinder head 70. The support element 56 is shaped as a bracket and is fixedly coupled to the fuel rail 18, for example by brazing or welding.

The coupling device 40 further comprises a second fastening element 58 which is in engagement with the support element 56. In the shown embodiment, the second fastening element 58 is a screw. The second fastening element 58 is extending into a blind hole 59 which is arranged in the cylinder head 70. If the second fastening element 58 is a screw, it can be in engagement with the cylinder head 70. By this the second fastening element 58 can be fixedly coupled to the cylinder head 70.

The coupling device 40 further comprises second spring elements 60. One second spring element 60 is arranged between the second fastening element 58 and the support element 56. A further second spring element 62 is arranged between the support element 56 and the cylinder head 70. The second spring elements 60, 62 consist of a plastic or comprise a plastic.

Due to the first spring elements 50, 52 a direct contact between the cylinder head 70 and the fuel injector cup 30 can be prevented. Consequently, a noise transmission between the cylinder head 70 and the fuel rail 18 can be kept small. A possible advantage that the first spring elements 50, 52 consist of a metal or comprise a metal is that the displacement of the fuel injector cup 30 and the fuel injector 20 can be kept small. Consequently, the variation of the position of the injection nozzle 29 can be kept small. Consequently, a favorable spray distribution in the combustion chamber 25 can be obtained.

Due to the second spring elements 60, 62 a direct contact between the cylinder head 70 and the support element 56 can be prevented. Consequently, a noise transmission between the cylinder head 70 and the fuel rail 18 can be kept small. A possible advantage that the second spring elements 60, 62 consist of a plastic or comprise a plastic is that a high elasticity between the fuel rail 18 and the cylinder head 70 can be obtained. Consequently, the tolerances of the components of the fuel feed device 10 which may result in mechanical stress in particular during the mounting of the fuel feed device 10 can be compensated in a very good manner.

The use of a metal for the first spring elements 50, 52 and the use of a plastic for the second spring elements 60, 62 result in a very good combination of a low stress for the components of the fuel feed device 10 in particular during the mounting of the fuel feed device 10 and an exact positioning of the fuel injector 20 in the cylinder head 70.

What is claimed is:

1. Coupling device for mechanically coupling a fuel rail to a cylinder head of a combustion engine, the coupling device comprising:
a fuel injector cup configured to be hydraulically and mechanically coupled to the fuel rail and arranged to face the cylinder head,
a first fastening element facing the fuel injector cup and configured to be fixedly coupled to the cylinder head,
at least one first spring element arranged between the first fastening element and the fuel injector cup,
a support element arranged between the fuel rail and the cylinder head and configured to be fixedly coupled to the fuel rail,
a second fastening element engage with the support element and configured to be fixedly coupled to the cylinder head, and
at least one second spring element arranged between the second fastening element and the support element,
wherein the at least one first spring element comprises a metal, and the at least one second spring element comprises a plastic.

2. The coupling device of claim 1, wherein one first spring element is arranged between the first fastening element and the fuel injector cup and a further first spring element is arranged between the fuel injector cup and the cylinder head.

3. The coupling device of claim 1, wherein one second spring element is arranged between the second fastening element and the support element and a further second spring element is arranged between the support element and the cylinder head.

4. The coupling device of claim 1, wherein at least one of the first and second fastening elements is a screw.

5. The coupling device of claim 1, wherein the fuel injector cup is configured to be hydraulically and mechanically coupled to the fuel rail is a pipe configured to enable a fluid flow from the fuel rail to a fuel injector.

6. The coupling device of claim 1, wherein the support element comprises a bracket.

7. The coupling device of claim 1, wherein the at least one first spring element are configured to prevent a direct contact between the cylinder head and the fuel injector cup.

8. The coupling device of claim 1, wherein the at least one second spring element are configured to prevent a direct contact between the fuel rail and the cylinder head.

9. An engine, comprising:
a cylinder head,
a fuel rail, and
a coupling device for mechanically coupling the fuel rail to the cylinder head of a combustion engine, the coupling device comprising:
a fuel injector cup hydraulically and mechanically coupled to the fuel rail and facing the cylinder head,
a first fastening element facing the fuel injector cup and fixedly coupled to the cylinder head,
at least one first spring element arranged between the first fastening element and the fuel injector cup,
a support element arranged between the fuel rail and the cylinder head and fixedly coupled to the fuel rail,
a second fastening element engaged with the support element and fixedly coupled to the cylinder head, and
at least one second spring element arranged between the second fastening element and the support element,
wherein the at least one first spring element comprises a metal, and the at least one second spring element comprises a plastic.

10. The engine of claim 9, wherein one first spring element is arranged between the first fastening element and the fuel injector cup and a further first spring element is arranged between the fuel injector cup and the cylinder head.

11. The engine of claim 9, wherein one second spring element is arranged between the second fastening element and the support element and a further second spring element is arranged between the support element and the cylinder head.

12. The engine of claim 9, wherein at least one of the first and second fastening elements is a screw.

13. The engine of claim 9, wherein the fuel injector cup is configured to be hydraulically and mechanically coupled to the fuel rail is a pipe configured to enable a fluid flow from the fuel rail to a fuel injector.

14. The engine of claim 9, wherein the support element comprises a bracket.

15. The engine of claim 9, wherein the at least one first spring element are configured to prevent a direct contact between the cylinder head and the fuel injector cup.

16. The engine of claim 9, wherein the at least one second spring element are configured to prevent a direct contact between the fuel rail and the cylinder head.
